(19) United States
(12) Patent Application Publication
(10) Pub. No.: US 2012/0242987 A1
(43) Pub. Date: Sep. 27, 2012

(54) SURFACE-ENHANCED RAMAN SCATTERING APPARATUS AND METHODS

(75) Inventors: Bing LIU, Ann Arbor, MI (US); Wei QIAN, Ann Arbor, MI (US); Makoto MURAKAMI, Ann Arbor, MI (US); Yong CHE, Ann Arbor, MI (US)

(73) Assignee: IMRA AMERICA, INC., Ann Arbor, MI (US)

(21) Appl. No.: 13/426,775

(22) Filed: Mar. 22, 2012

Related U.S. Application Data
(63) Continuation of application No. PCT/US12/29623, filed on Mar. 19, 2012.
(60) Provisional application No. 61/467,809, filed on Mar. 25, 2011.

(51) Int. Cl. G01J 3/44; B05D 3/06; B05D 7/22; B82Y 40/00; B82Y 30/00

(52) U.S. Cl. 356/301; 427/596; 427/597; 427/383.1; 977/773; 977/889

(57) ABSTRACT

An apparatus for performing surface-enhanced Raman scattering (SERS) is disclosed wherein an inner surface of a container is coated with SERS active materials such as nanoparticles of noble metals. Such a container can provide a partially enclosed, optical diffuse cavity whose inner surfaces serve for dual purposes of enhancing Raman scattering of the contained analyte and optical integration, therefore improving the efficiency of optical excitation and signal collection. The container may be configured to isolate the SERS active material from the external environment. The container, which may be a cylindrical tube, may be referred to as a SERS tube. Methods of coating the inner wall of a container with pulsed laser ablation and with nanoparticle colloids, respectively, are disclosed.

### FIELD OF INVENTION

This invention relates to surface-enhanced Raman scattering (SERS) for detecting molecules, particularly biological molecules.

### BACKGROUND

Surface-enhanced Raman scattering (SERS) is a sensitive analytical technique for detecting specific molecules. In the SERS method, normal Raman scattering is enhanced by roughened surfaces of metals such as gold, silver, and copper. In particular, nanometer-scaled roughness on the order of a few tens of nanometers (root mean square roughness between 10 nm −100 nm) has the most significant enhancing effect. For this purpose, there are numerous methods of preparing substrates with nanometer-scaled roughness. The most widely used nanometer-scaled surfaces are those of colloidal nanoparticles. For example, see Martin Maskovits, Surface-enhanced spectroscopy, Rev. Mod. Phys. 1985, vol. 57, No. 3, pp 783; and Kneipp et al., Ultrasensitive chemical analysis by Raman spectroscopy, Chem. Rev. 1999, vol. 99, pp 2957. A convenient way is to deposit colloidal Au or Ag or Cu nanoparticles with size between 5 nm-200 nm onto an inert substrate such as glass or silicon. Physical vapor deposition can also be used to deposit thin metal films with islanding morphology presenting roughness suitable for SERS. For example, see Gupta et al., Preparation and characterization of surface plasmon resonance tunable gold and silver films, J. Appl. Phys. 2002, vol 92, pp 5264. These SERS active surfaces often contain closely-packed nanometer-scaled features such as fractal aggregates of nanoparticles, characterized by small gaps and pores that strongly enhance Raman scattering, an effect sometimes called hot spots. For example, see Tsai et al., Photon scanning tunneling microscopy image of optical excitations of fractal metal colloid clusters, Phys. Rev. Lett. 1994, vol. 72, pp 4149. Alternatively, the surface of an inert substrate (for example silicon) can be roughened first to satisfy a roughness requirement. A thin layer of noble metal is coated afterwards to render the surface SERS active. For example, pulsed laser ablation has been utilized in roughening silicon surfaces, and SERS substrates have been produced by evaporating a thin layer of noble metal onto laser-roughened silicon surfaces. For example, see Diebold et al., Femtosecond laser-nanostructured substrates for surface-enhanced Raman scattering, Langmuir, 2009, vol. 25, pp 1790. Another technique of preparing SERS substrates is to engineer a substrate surface with precise lithography. For example, see Yan et al., Engineered SERS substrates with multiscale signal enhancement: nanoparticle cluster arrays, ACS Nano 2009, vol. 3, No. 5, pp 1190. Pre-designed nanometer-scaled sharp protrusions or gaps are provided to improve the repeatability of SERS measurements.

Notably, a practical difficulty with SERS substrates comes from contamination. Most SERS substrates are exposed to air for a long time before usage. Due to their very high specific surface area, the substrate surface can effectively trap hydro-carbon contaminants from the environment, and a molecular thin layer of organics is formed on the metal surface, reducing its effectiveness as a SERS substrate when performing measurement upon an analyte.

Efficient collection of SERS signal is another difficulty commonly encountered in SERS applications. Even with the strong enhancement of various nanometer-scaled features, SERS signals are still often weak. Simply increasing the excitation energy has limited effects due to the low damage threshold of many materials under examination, especially biological materials. In addition, SERS signals are emitted in random directions due to the random scattering nature of SERS. To collect a sufficient amount of SERS signal, microscope objectives with high numerical apertures are needed, often limiting both the working distance and the sampling volume. In fact, low efficiency of signal collection is a general problem in most Raman-related applications (except stimulated Raman emission). There have been many attempts to improve the signal collection efficiency based on various optical manipulations. For example, for standard Raman spectroscopy, optical confinement has been introduced, where the sample is placed inside a reflective cavity such as an optical integrating sphere. For example, U.S. Pat. Nos. 6,975,891, 4,645,340, 4,127,329, and 5,506,678 all teach various configurations for applying optical integration into standard Raman spectroscopy, such as with integration cavity, sphere, multiple mirrors, and tube, respectively. However, these systems are not only cumbersome, but are also not suitable for SERS because the cavity surfaces only serve for optical reflection.

By way of example, the following disclosures relate to the use of pulsed lasers to remove material from a target surface: Singh et al. “Pulsed-laser evaporation technique for deposition of thin films: Physics and theoretical model”, Physical Review B, Vol. 41, No. 13, 1 May 1990, 8843-8859; U.S. Pat. No. 5,656,186, entitled “Method for controlling configuration of laser induced breakdown and ablation”; U.S. Pat. No. 6,312,768, entitled “Method of deposition of thin films of amorphous and crystalline microstructures based on pulsed laser deposition”; U.S. Pat. No. 6,552,301, entitled “Burst-ultrafast laser machining method”; U.S. Patent Application Pub. No. 2009/0246530, entitled “Method for fabricating thin films”; and U.S. Patent Application Pub. No. 2010/0196192, entitled “Production of metal and metal-alloy nanoparticles with high repetition rate ultrafast pulsed laser ablation in liquids”.

### SUMMARY OF INVENTION

An object of the present invention is to provide a partially enclosed container for SERS applications, wherein an inner surface of the container is rendered SERS active.

Another object of the present is to provide methods for rendering at least a portion of an inner surface of a container SERS active, more specifically by coating the inner surface with SERS active materials.

Another object of the invention is to apply energy to a target positioned in a container, for example with a pulsed laser, to ablate or otherwise modify a target to create nanoparticles, and to coat the nanoparticles on an inner surface of the container in such a way as to render the inner surface SERs active.

In at least one embodiment the container comprises a cylindrical tube with an inner surface rendered SERS active. Such a tube is sometimes referred to as a SERS tube in the present disclosure, but is not to be construed as restricted to a cylindrical shape unless otherwise stated. The container may comprise a rigid or flexible cylindrical shaped portion, with the cylinder length greater than the diameter. The container may comprise one or both of an opaque or transparent outer surface. The container is generally configured in such a way as to be suitable for efficient deposition of SERS active material on at least a portion of an inner surface. In some preferred embodiments pulsed laser deposition is used to coat nanoparticles on an inner surface of the tube. Colloidal nanoparticles can also be used for such purpose.

Such a container has multiple functions for SERS applications. First, an inner surface of the container is rendered SERS active and enhances Raman scattering. Second, the partially reflective inner surface, combined with the partially enclosed geometric shape of the container, helps to optically confine both the excitation and the SERS signal by multiple scattering, therefore improving the efficiency of both excitation and signal collection. Third, the container can be sealed to prevent contamination from the environment during storage. Fourth, in subsequent use in measurement, the container will hold the analyte under test.

The present invention also provides methods of rendering an inner surface of a container SERS active, for example by coating the inner surface with SERS active materials comprising nanoparticles of noble metals. At least one embodiment provides a method of pulsed laser ablation to coat an inner wall of a transparent container with noble metal nanoparticles. Other metal nanoparticles may be utilized for various applications. Another embodiment provides a method of coating with colloidal nanoparticles.

Some embodiments also provide a method of collective processing for SERS applications in which an array of SERS tubes is utilized to improve repeatability and throughput of signal processing.

For purposes of summarizing the present invention, certain aspects, advantages and novel features of the present invention are described herein. It is to be understood, however, that all such advantages are not necessarily achieved in accordance with any particular embodiment Thus, the present invention may be embodied or carried out in a manner that achieves one or more objects or advantages without necessarily achieving other objects or advantages as may be taught or suggested herein.

### BRIEF DESCRIPTION OF THE DRAWINGS

FIG. 1 schematically illustrates an example of a SERS apparatus: SERS tube 101 comprises an inner surface coated with SERS active materials 102. The tube also acts as the container for the analyte under test 103. Optical excitation and collection for SERS analysis can be performed either from the outside of the tube with optics 104 or from one end of the tube with optics 105.

FIG. 2 schematically illustrates a cross-sectional, end view into a SERS tube, illustrating multiple optical scattering.

FIG. 3 schematically illustrates multiple optical scattering in a SERS tube with one end of the tube sealed, the end also being coated interiorly with SERS active materials.

FIG. 4 schematically illustrates a cross-sectional, end view into a SERS tube with an additional reflective layer 104 beneath the SERS active materials.

FIG. 5 schematically illustrates a cross-sectional, end view into a SERS tube containing an additional cylinder 105 whose outer surface is also coated with SERS active materials.

FIG. 6 schematically illustrates a cross-sectional, end view into a SERS tube with a flat window for optical excitation and signal collection.

FIG. 7 schematically illustrates a cross-sectional, end view of a SERS tube with an inner surface 106 roughened to nano-meter scales and coated with a layer of SERS active material 107.

FIG. 8 schematically illustrates a portion of a pulsed laser ablation system configured for coating the inner surface of a tube. The laser beam 201 is focused through a lens 202 onto a target 203 that is inserted into the tube, and nanoparticles 204 are deposited on the inner wall of the tube.

FIG. 9 schematically illustrates a portion of a pulsed laser ablation system disposed outside of a transparent tube to coat the tube's inner surface with SERS active materials. The laser beam 201 is directed with a moving mirror 205, for example a rocking mirror, and focused through lens 202 onto the surface of the target 203. The mirror 205 provides lateral scanning of the laser beam. In this example tube 101 rotates about its axis during ablation.

FIG. 10 illustrates the portion near the ablation region of the configuration of FIG. 9.

FIG. 10a illustrates an alternative configuration of a SERS apparatus having an annular inner portion coated with SERS active material.

FIG. 11 illustrates coating the inner wall of a tube with colloidal nanoparticles. Colloidal nanoparticle solution 301 is injected into tube first. After drying, nanoparticles 302 remain on the inner surface of the tube.

FIG. 12 schematically illustrates a capillary tube 401 with a portion of its inner surface rendered SERS active.

FIG. 13 illustrates an array of SERS tubes for collective signal processing.

FIG. 14 illustrates a SERs apparatus in which an optical fiber 501 is used for transmitting both the optical excitation and the SERS signal.

FIG. 15 illustrates a portion of a spectroscopy system utilizing an optical fiber bundle 502 for SERS measurements, wherein each single fiber is used for an individual SERS tube.

FIG. 16 is a plot illustrating a SERS spectrum of crystal violet molecules, taken with a SERS tube containing a test aqueous solution of 10 ppm crystal violet.

### DETAILED DESCRIPTION

As used herein noble metals are to be understood as being group of metals corresponding with, and inclusive of multiple conventional definitions, rather than restricted. The noble metals comprise a property of being non-reactive and having resistance to corrosion and oxidation. By way of example, Ag, Au, and Pt satisfy such a condition. However, for example, Cu may be suitable for use in some embodiments of the present invention, notwithstanding its reduced resistance to corrosion and oxidation.

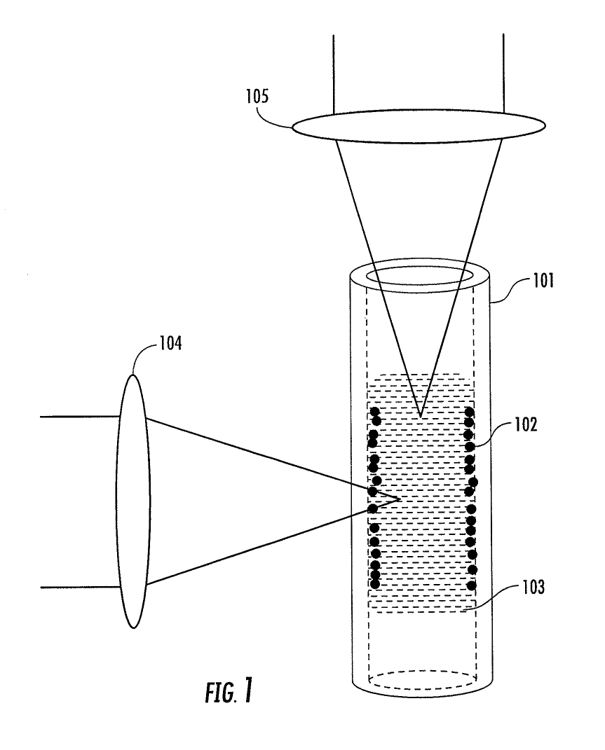

FIG. 1 illustrates a SERS apparatus in which an inner surface of container 101 is coated with a layer of SERS active material 102. The material 102 preferably comprises nanoparticles of noble metals such as Au, Ag, Cu, and their alloys, and more generally, metals or metal alloys supporting surface plasmon resonance (SPR) or the excitation of surface plasmons thereon for SERS generation. Such a SERS tube, in use, will function as the container of the intended analyte 103. The SERS active inner surface enhances Raman scattering. Optical excitation and/or SERS signal collection can be interchangeably performed either from outside the tube with optics 104 or from an end of the tube with optics 105.

The container can be made of any suitable combination of transparent and opaque materials. Glass and quartz are preferred for their high optical transparency over a broad wavelength range, and chemical inertness. Ceramic tubing is also workable with its porous adsorbing surfaces. Semiconductor and noble metals may be utilized, but are more expensive. In some embodiments the container may be generally cylindrical in shape, with the cylinder length greater than the outer diameter. For example, the container may be a cylindrical tube as illustrated in FIG. 1. The cylinder may be characterized by a major axis along its length. However, the shape of the container is not restricted to a cylindrical form. For example, at least a portion of suitable container may be characterized by a cross-section in the form of a symmetric or asymmetric polygonal shape. Moreover, a SERS apparatus may comprise a container having either flexible and/or rigid portions defining a curvilinear or other non-linear path. In at least one preferred implementation a SERs tube is partially enclosed. Generally, a SERS container will be configured suitably for the excitation and collection beams, and for efficient deposition of SERS material on at least one internal surface. In various embodiments a SERS tube may be sealed or otherwise isolated from the external environment.

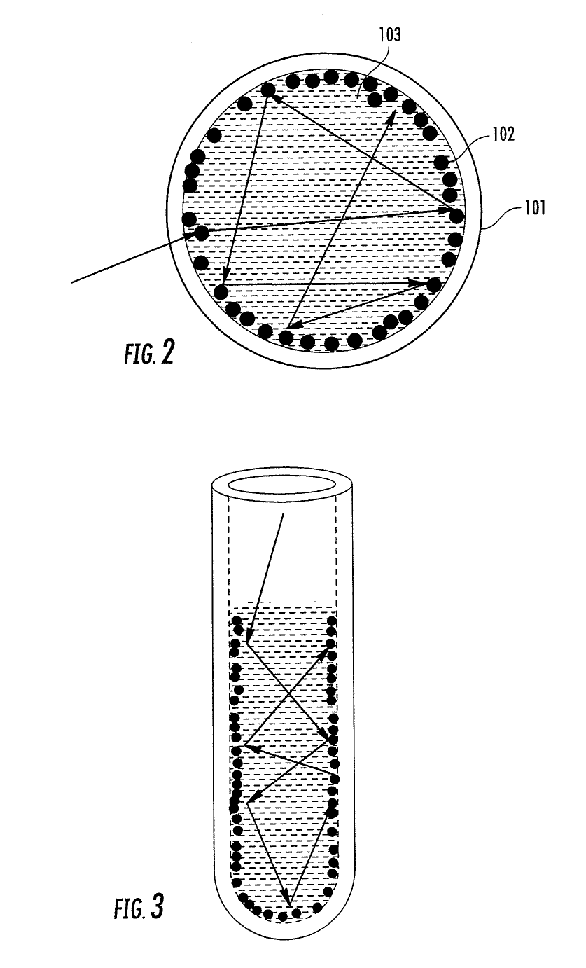

There are several advantages of such a SERS container with the partially enclosed geometry. First, the metal nanoparticles cause multiple optical scattering in random directions, making the inner wall of the container optically diffuse, as illustrated in FIG. 2. For a tube container, the bottom of the tube can also be sealed and coated with SERS active materials, forming a nearly closed cavity. Such a cavity, with the rough, optically diffuse, inner surface can uniformly distribute electromagnetic waves within the confined space. Thus, the arrangement can effectively act as an optical integrator, which therefore improves both the excitation and signal collection efficiency, regardless of the location of the excitation light source and the signal collector.

In various embodiments optical confinement relies on diffuse reflectivity of the cavity inner surface (i.e., the internal wall). To obtain high reflectivity, a reflective coating 104 can be applied on the inner wall surface before the SERS materials is coated, as illustrated in FIG. 4. The reflective coating 104 can comprise a layer of a noble metal such as Au or Ag. In some embodiments Cu, Al, or a dielectric coating having a spectral band of reflection covering the excitation and SERS signal wavelength may be utilized. In some embodiments a non-noble metal having high resistance to corrosion and oxidation may be utilized.

To increase the ratio between the area of SERS active surface and the analyte volume without reducing the size of the SERS container, a second SERS active surface can be introduced into the SERS container. For example for a tube container, a cylinder 105 may be inserted with its outer cylindrical surface coated with SERS active materials, as illustrated in FIG. 5.

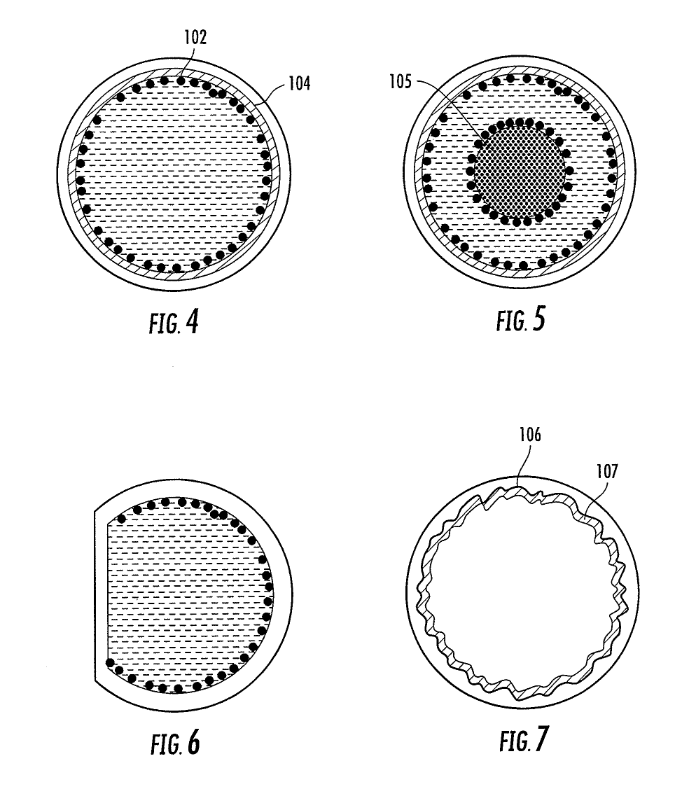

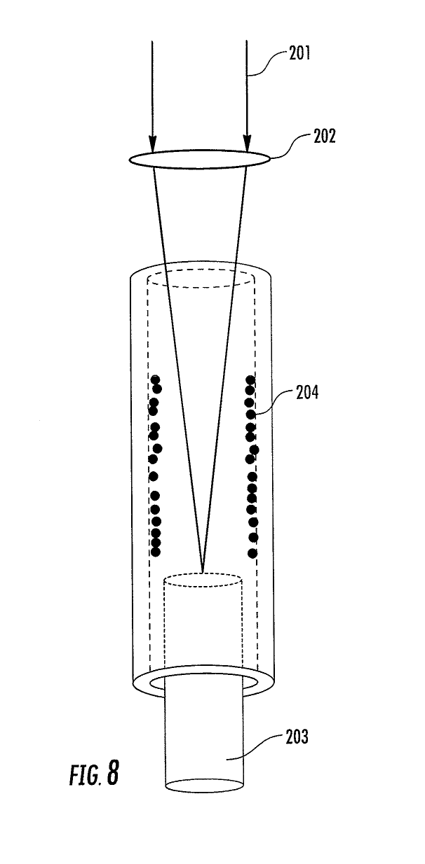

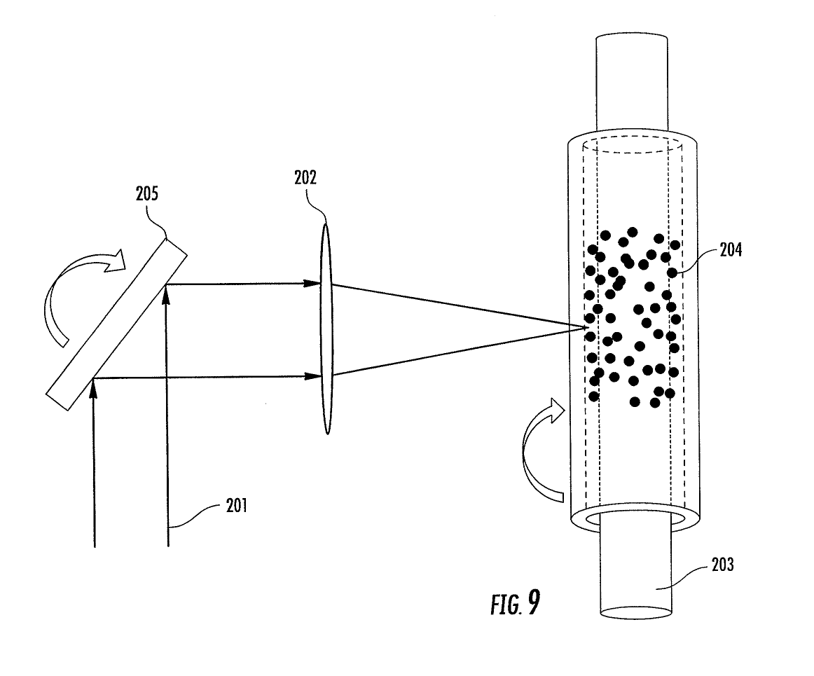

For excitation and signal collection from outside the SERS container, a portion of the container can be fabricated as a flat window to minimize optical distortion and/or aberrations, as illustrated in FIG. 6 for a tube container.

Another advantage is that a SERS tube can be sealed on both ends after fabrication and remain clean until actual usage, thereby avoiding elongated exposure to the ambient and accumulation of contaminants.

In various embodiments the tube container inner diameter (ID) can range between approximately 0.1 mm to 10 mm, and the wall thickness can range between about 0.1 mm to about 10 mm. The tube length can range between approximately 1 mm-100 mm.

In the examples below we introduce several methods of rendering the inner surface of a tube container to be SERS active.

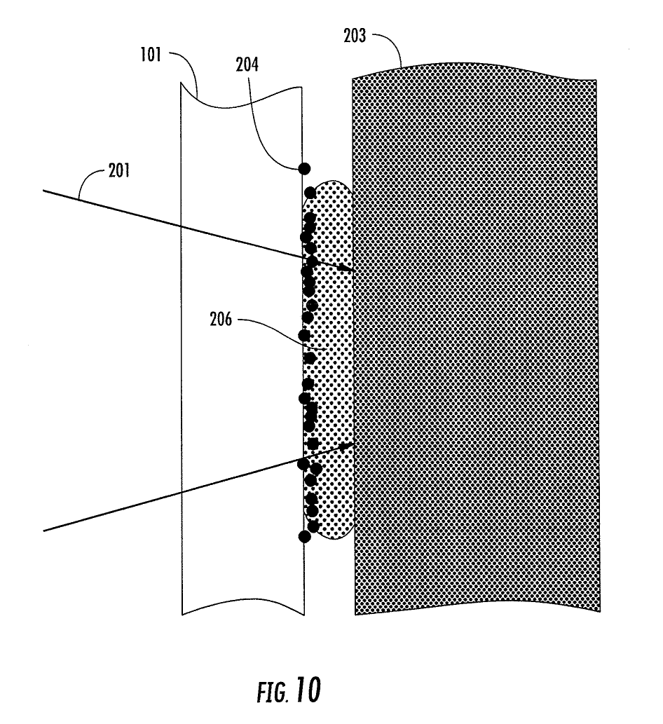

The method illustrated in FIG. 7 first introduces nanoscaled roughness on the inner wall 106 of the tube and then coats the inner wall with a layer of SERS active metal 107. For glass or quartz tubes, both chemical etching and physical etching methods are effective. Chemical etching has high etching speed but utilizes corrosive acids such as hydrofluoric acid (HF). Physical etching, such as with gas discharge plasma, does not require special precautions and is generally environmentally friendly. Thus, physical etching is more preferred than chemical etching. The average roughness (i.e., root mean square roughness) is preferably between approximately 10 nm-200 nm, which is adjustable with different etching times. The surface active material 107 can be a layer of chemically coated metal such as Au, Ag, or Cu. The well-known Tollen's reagent for coating a silver minor on glassware is convenient for this purpose.

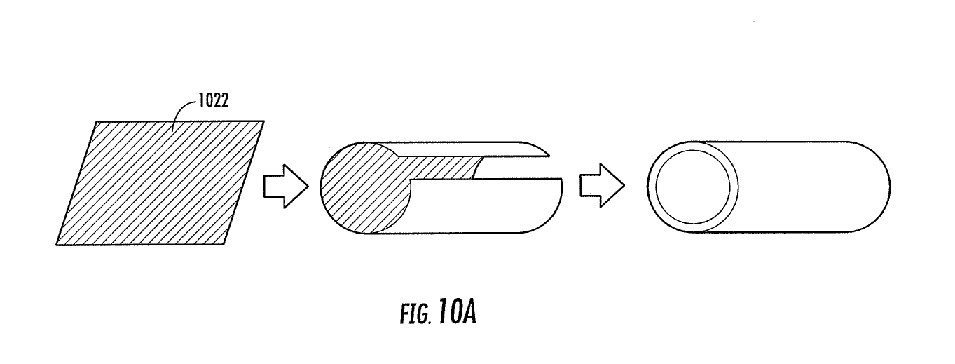

Another embodiment includes coating nanoparticles of metals onto the inner wall of a tube container. The method may include pulsed laser ablation. FIG. 8 shows an arrangement for coating nanoparticles on the inner wall of a tube with pulsed laser ablation. A laser beam 201 is focused with the lens 202 onto one end of a cylindrical target 203 that is fed into the tube from the opposite end. The numerical aperture (NA) of the focused beam is configured to match the acceptance angle of the tube to suitably irradiate a sample therein. For example, for a tube inner diameter of d=3 mm and a tube length of L=10 mm, the NA of the beam is preferably below d/2L=0.15. The target material can be those most widely used for SERS applications, e.g., Au, Ag, Cu, and alloys thereof. The focused laser beam ablates the target tip and the vapor is deposited on the inner wall of the tube, forming metal nanoparticles 204.

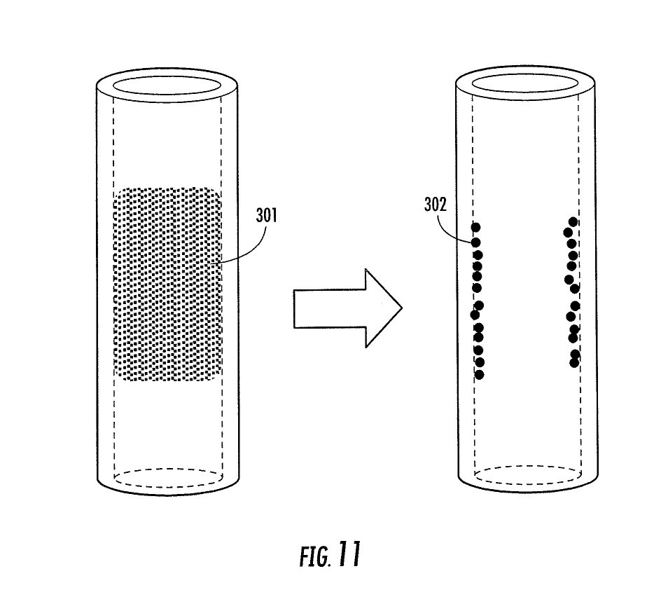

An alternative arrangement for pulsed laser ablation to coat nanoparticles onto the inner wall of a transparent tube is illustrated in FIG. 9. In this example the focused laser beam is incident through the transparent wall of the tube and ablates the cylindrical surface of the target inside the tube. Such a tube can be made of transparent materials such as glass or quartz.

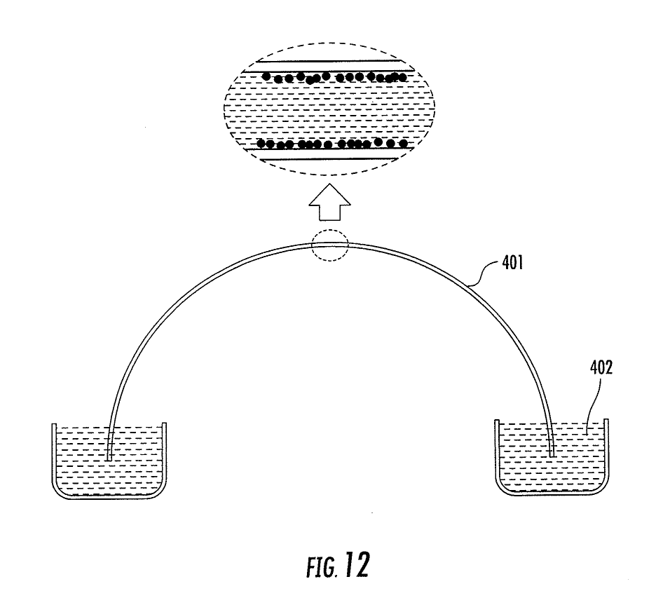

FIG. 10 illustrates the vicinity of the ablation region of FIG. 9 in more detail. The laser first passes through the transparent tube wall then focuses on the target surface. The laser ablates a portion of the target material, and the resulting vapor 206 (e.g.: plume) expands in the gap between the tube wall and the target, and cools down on the tube wall, forming nanoparticles thereon.

In the laser ablation arrangement of FIG. 9, linear beam scanning may be implemented with a rocking (oscillating) minor 205, or other suitable scanning configuration. The mirror is preferably positioned at the back focal point of the focusing lens 202 for telecentric scanning such that the foci of the laser beam form a straight line on the target surface. During ablation, the tube is kept rotating about its major axis to spread the coating uniformly on the inner wall.

Many alternative possibilities exist. For example, a container 101 need not be a single piece, but may be assembled in portions. The container may comprise multiple inner surfaces. For example, as illustrated in FIG. 10a, a flexible sheet 1022 may be coated with a SERS active material or surface engineered to become SERS active by lithography or nano-imprinting in an initial fabrication step. The sheet may then be formed (e.g.: rolled) into an annular shape (e.g.: a ring) having an outer diameter smaller than that of tube 101. The annular portion is then inserted into the container, for example by sliding, and then affixed to the interior portion of the container. Thus, the inner-most surface of the container is coated with a SERS active material and may be utilized for analysis or measurement of a substance, chemical constituent or other sample to be tested.

Pulsed lasers with nanosecond (1-100 ns), picosecond (1-1000 ps), or femtosecond (1-1000 fs) pulse durations can be utilized in various embodiments. Preferably, a femtosecond laser with a pulse duration between 10-500 fs can be used for ablation. Well-known advantages of femtosecond lasers in ablation include low ablation threshold(s) and less heat generation during ablation, therefore reducing any damage the tube wall surface.

US Patent Application No. 12/400,438 (U.S. Patent Application Pub. No. 2010/0227133), entitled “Pulsed laser micro-deposition formation”, filed Mar. 9, 2009, is hereby incorporated by reference in its entirety. The '438 application discloses, among other things, a method of coating materials onto transparent media, where a high repetition rate pulsed laser is used. The repetition rate can range from about 0.1-100 MHz, and the pulsed duration can range from about 10 fs to 100 ns. Such a pulsed laser system may be utilized in various embodiments for depositing nanoparticles on an inner wall of a tube to coat the tube and render the surface SERs active.

In addition to direct deposition with pulsed laser ablation, or as an alternative, wet chemical methods can be used to coat the inner wall of a container with metal nanoparticles. FIG. 11 illustrates such a process for a tube container. The tube is first filled with a nanoparticle colloidal solution 301. Upon heating, the solvent evaporates, and the nanoparticles 302 become deposited on the tube inner wall.

There are numerous methods of producing nanoparticle colloids. The most widely used is chemical synthesis by reducing metal salts in solvents. The chemical methods can produce nanoparticles with size in the range from about 5-500 nm. Pulsed laser ablation in solvents is also an established method of producing metal nanoparticle colloids, with nanoparticles of size also between 5-500 nm. U.S. Patent Application No. 12/320,617 (Pub. No. 2010/0196192) entitled “Production of metal and metal-alloy nanoparticles with high repetition rate ultrafast pulsed laser ablation in liquids”, filed Jan. 30, 2009, is hereby incorporated by reference in its entirety. The '617 Application discloses, among other things, a laser ablation method of producing nanoparticle colloids in various solvents.

Volatile solvents such as methanol, acetone, alcohol and isopropanol are preferred for quick evaporation. Vaporization of solvents can be induced by externally heating a portion of the tube to near the boiling point of the solvent.

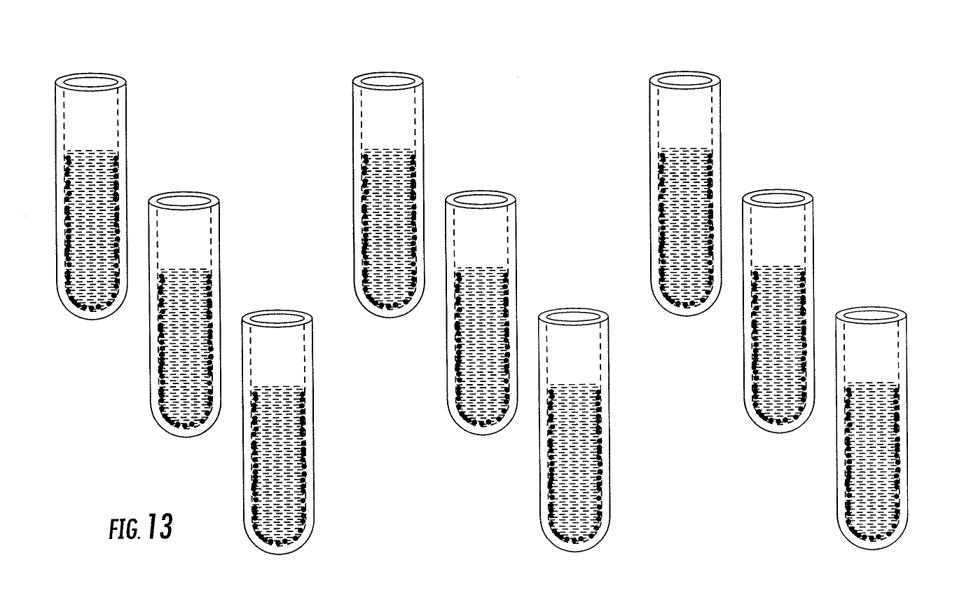

The wet coating method for rendering at least a portion of an inner surface of a container SERS active can be applied to a capillary tube. For example, a small portion of a capillary tube 401 can be coated with SERS active materials, as illustrated in FIG. 12. This enables combination of SERS with other analytical methods such as electrophoresis for dynamical study of a flowing analyte 402.

One of the often encountered problems in SERS applications is deficient measurement repeatability. There are several reasons, including low signal strength and a corresponding low signal to noise ratio. Notably, SERS largely relies on so-called ‘hot spots’ which are closely packed nano-scaled features such as aggregates (e.g., pairs, chains, clusters) of nanoparticles. Although these closely packed random features have a higher enhancement factor than dispersed single nanoparticles, the inherent randomness and statistical non-stationary behavior causes lack of control and predictability. Averaging of multiple measurements on a single SERS substrate does not improve repeatability. Measurement on multiple substrates is needed, which causes high cost of measurement and low throughput.

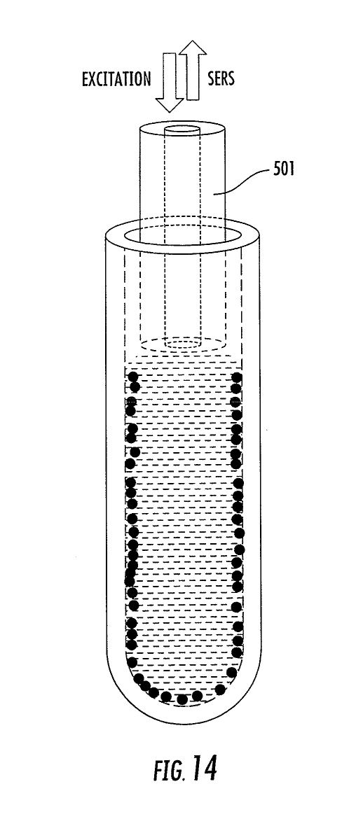

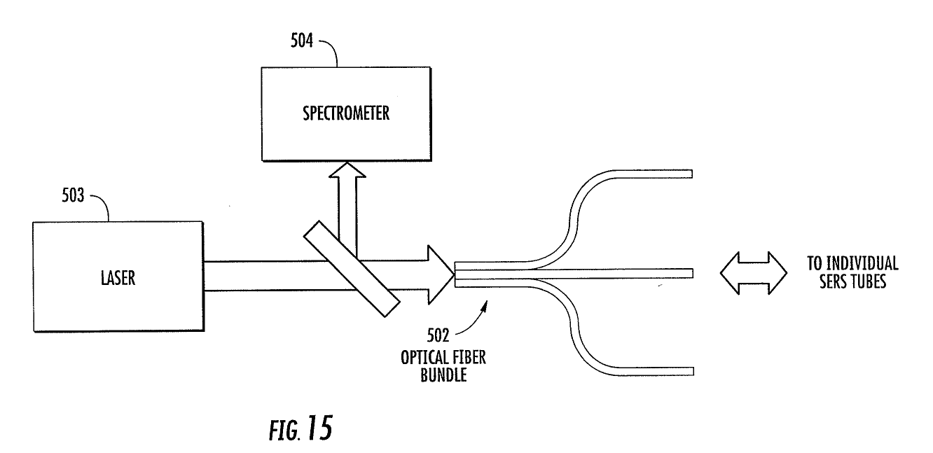

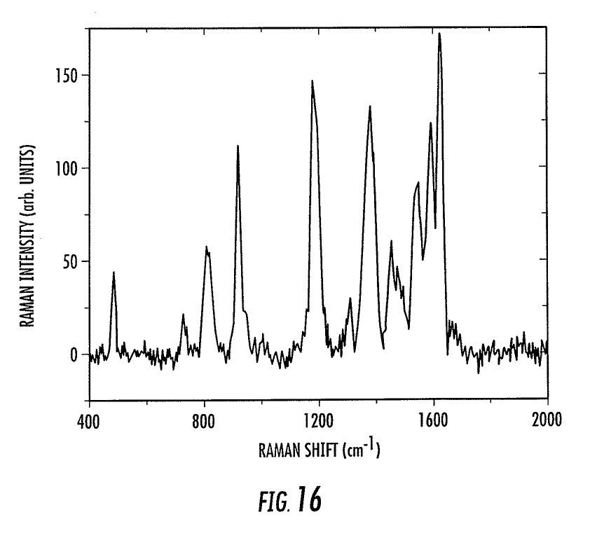

FIG. 13 illustrates an array of SERS tubes for collective processing of SERS measurements. In this example, optical excitation and signal collection can be done through optical fibers, as illustrated in Figure. 14. An optical fiber 501 is used for both transmitting the excitation laser and collecting the SERS signal. The NA of the fiber should be sufficiently large to collect a large fraction of radiation emitted from the tube, so as to obtain a high signal to noise ratio. Away from the tubes, as illustrated in FIG. 15, the fibers can be made into a bundle 502 for receiving the excitation laser 503 and feeding the SERS signal to the spectrometer 504. In this way, the aforementioned deficiencies can be overcome. An effective parallel process as illustrated in FIG. 13 improves measurement repeatability, processing speed, and overall throughput.

### EXAMPLE

As an example, FIG. 16 shows a SERS spectrum of crystal violet (which is a widely used dye for indicating SERS activity) taken with a single SERS tube. The analyte was prepared as an aqueous solution of 10 ppm crystal violet. In making the SERS tube, a colloidal solution of Au nanoparticles was first produced by femtosecond pulsed laser ablation of Au in a liquid solvent. The target was a sheet of Au metal, and acetone was chosen as the solvent for its high volatility. During ablation, the target was submerged in acetone, and the colloid was formed directly in acetone. The laser had a pulse energy of 10 micro Joules, a pulse duration of 500 femtoseconds, and a repetition rate of 10 MHz. Notably, as previously discovered and disclosed in U.S. patent application Ser. No. 12/320,617, the colloid can remain for several months as a stable suspension without additional stabilizing chemicals. The colloid was then injected into a glass tube with an inner diameter of 2 mm and wall thickness of 0.5 mm. The tube was heated to above 60° C. to evaporate the acetone solvent. After drying, a layer of Au nanoparticles was left on the inner wall of the tube, rendering the inner surface SERS active. 30 μL of analyte was injected into such a SERS tube of 1 cm length. Optical excitation was generated with a 532 nm laser through the side of the SERS tube and the SERS signal was retrocollected with the same lens, as illustrated in FIG. 1, with optics 104 used for both transmission and receiving. The result shown in FIG. 16, which exhibits a high signal-to-noise ratio, establishes the capability of SERS tubes disclosed herein in strongly facilitating SERS performance.

Various aspects related to SERS substrates are further discussed in U.S. patent application Ser. No. 12/951,524 entitled “Method and apparatus to prepare a substrate for molecular detection”, filed Nov. 22, 2010, the contents of which are hereby incorporated by reference in their entirety. For example, a method of forming a SERS active metal surface on a substrate for Raman spectroscopy and the product &piffled by the method is disclosed. The method comprises the steps of providing a substrate or support material having a relatively flat surface and applying a nano-structured metal layer to the surface in a single step by a process comprising ultrashort pulsed laser deposition, ultrashort backside transfer pulsed laser deposition, or sputtering, thereby forming the substrate for Raman spectroscopy. The product can be used in surface enhanced Raman spectroscopy (SERS), surface enhanced resonance Raman spectroscopy (SERRS), surface enhanced hyper Raman spectroscopy (SEHRS), surface enhanced coherent anti-Stokes Raman spectroscopy (SECARS), and surface enhanced infrared absorption (SEIRA). The method is rapid, inexpensive, highly reproducible and tunable for optimization of detection based on the active metal used or the substance being detected. The method permits a thickness gradient of the active metal layer to be applied to the surface so that the optimum thickness for detection of a compound of interest can easily be determined by coordinating signal intensity with position on the gradient. The method also permits the substrate surface to be pre-coated with other materials prior to applying the active metal surface to enhance the Raman signal derived from the active metal layer. In that embodiment disclosed in the '524 application, the SERS active metal is not directly bonded to the substrate surface.

Thus, the invention has been described in several embodiments. It is to be understood that the embodiments are not mutually exclusive, and elements described in connection with one embodiment may be combined with, or eliminated from, other embodiments in suitable ways to accomplish desired design objectives.

At least one embodiment includes an apparatus for surface-enhanced Raman scattering (SERS). The apparatus includes: a container having an inner surface, wherein at least a portion of the inner surface is coated with a SERS active material.

In any or all embodiments SERS active material may comprises nanoparticles, and the nanoparticles may comprise gold, silver, copper, or their alloys.

In any or all embodiments SERS active material may comprises nanoparticles having a size in the range from about 5 nm to about 500 nm.

In any or all embodiments nanoparticle sizes may be in the range from about 5 nm to about 200 nm.

In any or all embodiments a container may comprise transparent material.

In any or all embodiments a transparent material may comprise glass or quartz.

In any or all embodiments at least one end of a container may be sealed.

In any or all embodiments a container may have an inner diameter between about 0.1 mm and about 10 mm.

In any or all embodiments a container may have a thickness between an inner surface and an outer surface in the range from about 0.1 mm and about 10 mm.

In any or all embodiments a length of a container may be between about 1 mm to about 100 mm.

In any or all embodiments a container may comprise an annular portion disposed therein, the annular portion having a SERS active material coated on at least an inner surface of the annular portion.

In any or all embodiments a container may comprise a rigid or flexible tube generally cylindrical in shape.

In any or all embodiments at least a portion of a container has a cross-section in the shape of a symmetric or asymmetric polygon.

At least one embodiment includes a method of coating nanoparticles onto the inner surface of a container. The method includes inserting a target in the container and directing a pulsed laser beam into the container and toward the target. The beam is incident from an end of the container. The method includes ablating a target material with the pulsed laser beam to create nanoparticles, and depositing the nanoparticles on an inner surface of the container to coat the inner surface.

In any or all embodiments a pulsed laser may generates pulses having pulse duration in the range from about 10 fs to 100 ns.

In any or all embodiments pulses may have a pulse width in the range from about 0.1-10 ps

In any or all embodiments target material may comprise gold, silver, copper or an alloy thereof.

At least one embodiment includes a method of coating nanoparticles onto an inner surface of a transparent container. The method includes inserting a target in the container and directing a pulsed laser beam from outside the transparent container and through at least one wall of the container. The pulsed laser beam is directed so as to impinge the target in the container with the pulsed laser beam. The method includes ablating the target material with the pulsed laser beam to create nanoparticles and depositing the nanoparticles on the inner surface of the container to coat the inner surface.

In any or all embodiments a pulsed laser may generate pulses having a pulse duration in the range from about 10 fs to about 100 ns.

In any or all embodiments pulses may have a pulse width in the range from about 0.1-10 ps

In any or all embodiments target material may comprise gold, silver, copper or their alloys.

In any or all embodiments a pulsed laser beam may be scanned by moving a mirror relative to a surface of the target.

In any or all embodiments a container may be translated along a container axis during a step of directing a pulsed laser beam from outside the container to impinge the target.

In any or all embodiments a container may be translated along the length of the container axis during a step of directing

In any or all embodiments a container may be rotated about an axis of rotation during a step of directing a pulsed laser beam from outside the container to impinge the target.

At least one embodiment includes a method of coating nanoparticles onto an inner surface of a container. The method includes injecting a colloidal solution of nanoparticles of gold, silver, or copper, or their alloys into the container. The method further includes evaporating a solvent of the colloidal solution to deposit the nanoparticles onto an inner surface of the container. The nanoparticles remain on the inner surface subsequent to the step of evaporating.

In any or all embodiments a solvent of the nanoparticle colloid may comprise water.

In any or all embodiments a solvent of the nanoparticle colloid may comprise an organic solvent, comprising: acetone, or methanol, or isopropanol, or ethanol, or alcohols.

In any or all embodiments evaporation may be induced by heating the container to near the boiling point of the solvent.

In any or all embodiments nanoparticles of colloidal solution may be generated with pulsed laser ablation of a target in liquid.

At least one embodiment includes a spectroscopy system for performing Surface-enhance Raman Scattering (SERS). The system includes an array of containers, each container comprising an apparatus for surface-enhanced Raman scattering (SERS). The apparatus for SERS may include a container having an inner surface, wherein at least a portion of the inner surface is coated with a SERS active material. The system further includes a plurality of optical fibers, wherein each fiber is inserted into an individual container in the array of containers to transmit an excitation signal and to collect SERS signal.

At least one embodiment includes a method of coating nanoparticles onto the inner surface of a container. The method includes inserting a target in the container and directing a pulsed laser beam into the container, the beam being incident from an end of the container. The method includes removing a portion of the target with the laser to create nanoparticles, and depositing the nanoparticles on an inner surface of the container.

At least one embodiment includes a method of coating nanoparticles onto an inner surface of a transparent container. The method includes inserting a target in the container and directing a pulsed laser beam from outside the container, and through at least one wall of the transparent container, so as to impinge the target in the transparent container with the pulsed laser beam. The method includes removing a portion of the target with the pulsed laser beam to create nanoparticles, and depositing the nanoparticles on an inner surface of the container, and depositing the nanoparticles on the inner surface of the container.

Thus, while only certain embodiments have been specifically described herein, it will be apparent that numerous modifications may be made thereto without departing from the spirit and scope of the invention. It is a goal of the invention to achieve one or more objects of the invention, although the invention may be practiced without the full achievement of any one of these objects. Further, acronyms are used merely to enhance the readability of the specification and claims. It should be noted that these acronyms are not intended to lessen the generality of the terms used and they should not be construed to restrict the scope of the claims to the embodiments described therein.

What is claimed is:

1. An apparatus for surface-enhanced Raman scattering (SERS), comprising: a container having an inner surface, wherein at least a portion of said inner surface is coated with a SERS active material.

2. The apparatus of claim 1, wherein said SERS active material comprises nanoparticles, said nanoparticles comprising gold, silver, copper, or their alloys.

3. The apparatus of claim 1, wherein said SERS active material comprises nanoparticles having a size in the range from about 5 nm to about 500 nm.

4. The apparatus of claim 3, wherein said size is in the range from about 5 nm to about 200 nm.

5. The apparatus of claim 1, wherein said container comprises transparent material.

6. The apparatus of claim 5, wherein said transparent material comprises glass or quartz.

7. The apparatus of claim 1, wherein at least one end of said container is sealed.

8. The apparatus of claim 1, wherein said container has an inner diameter between about 0.1 mm and about 10 mm.

9. The apparatus of claim 1, wherein said container has a thickness between said inner surface and an outer surface in the range from about 0.1 mm and about 10 mm.

10. The apparatus of claim 1, wherein the length of said container is between about 1 mm to about 100 mm.

11. The apparatus of claim 1, wherein said container comprises an annular portion disposed therein, said annular portion having a SERS active material coated on at least an inner surface of said annular portion.

12. The apparatus of claim 1, wherein said container comprises a rigid or flexible tube generally cylindrical in shape.

13. The apparatus of claim 1, wherein at least a portion of said container has a cross-section in the shape of a symmetric or asymmetric polygon.

14. A method of coating nanoparticles onto the inner surface of a container, comprising:
inserting a target in said container;
directing a pulsed laser beam into said container and toward said target, said beam being incident from an end of said container;
ablating a target material with said pulsed laser beam to create nanoparticles; and
depositing said nanoparticles on an inner surface of said container to coat said inner surface.

15. The method of claim 14, wherein said pulsed laser generates pulses having a pulse duration in the range from about 10 fs to 100 ns.

16. The method of claim 15, wherein said pulses have a pulse width in the range from about 0.1-10 ps

17. The method of claim 14, wherein said target material comprises gold, silver, copper or an alloy thereof.

18. A method of coating nanoparticles onto an inner surface of a transparent container , comprising:
inserting a target in said container;
directing a pulsed laser beam from outside said transparent container and through at least one wall of said container so as to impinge said target in said container with said pulsed laser beam;
ablating a target material with said pulsed laser beam to create nanoparticles; and
depositing said nanoparticles on said inner surface of said container to coat said inner surface.

19. The method of claim 18, wherein said pulsed laser generates pulses having a pulse duration in the range from about 10 fs to about 100 ns.

20. The method of claim 19, wherein said pulses have a pulse width in the range from about 0.1-10 ps

21. The method of claim 18, wherein said target material comprises gold, silver, copper or their alloys.

22. The method of claim 18, wherein said pulsed laser beam is scanned by moving a mirror relative to a surface of said target.

23. The method of claim 18, comprising: translating said container along its axis during said step of directing.

24. The method of claim 18, wherein said method comprises: translating said container along the length of said container said first axis during said step of directing.

25. The method of claim 18, wherein said method comprises: rotating said container about an axis of rotation during said step of directing.

26. A method of coating nanoparticles onto an inner surface of a container, comprising
injecting a colloidal solution of nanoparticles of gold, silver, or copper, or their alloys into said container; and
evaporating a solvent of said colloidal solution to deposit said nanoparticles onto said inner surface of said container, wherein said nanoparticles remain on said inner surface subsequent to said step of evaporating.

27. The method of claim 26, wherein the solvent of said nanoparticle colloid comprises water.

28. The method of claim 26, wherein the solvent of said nanoparticle colloid comprises an organic solvent, comprising: acetone, or methanol, or isopropanol, or ethanol, or alcohols.

29. The method of claim 26, wherein the evaporation is induced by heating said container to near the boiling point of said solvent.

30. The method of claim 26, wherein said nanoparticles of colloidal solution are generated with pulsed laser ablation of a target in liquid.

31. A spectroscopy system for performing Surface-enhance Raman Scattering (SERS), comprising:
an array of containers, each container comprising an apparatus as claimed in claim 1; and
a plurality of optical fibers, wherein each fiber is inserted into an individual container in said array of containers to transmit an excitation signal and to collect SERS signal.

32. A method of coating nanoparticles onto the inner surface of a container, comprising:
inserting a target in said container;
directing a pulsed laser beam into said container, said beam being incident from an end of said container;
removing a portion of said target with said laser to create nanoparticles; and
depositing said nanoparticles on an inner surface of said container.

33. A method of coating nanoparticles onto an inner surface of a transparent container, comprising:
inserting a target in said container;
directing a pulsed laser beam from outside said container and through at least one surface of said container to impinge said target in said container with said pulsed laser beam; and
removing a portion of said target with said pulsed laser beam to create nanoparticles; and
depositing said nanoparticles on said inner surface of said container.
